(19) United States
(12) Patent Application Publication
(10) Pub. No.: US 2021/0117125 A1
(43) Pub. Date: Apr. 22, 2021

(54) SERVER SYSTEM WITH SOLID STATE DRIVES AND ASSOCIATED CONTROL METHOD

(71) Applicant: LITE-ON TECHNOLOGY CORPORATION, Taipei (TW)

(72) Inventors: Shih-Hung HSIEH, Taipei (TW); Yu-Cheng KAO, Taipei (TW); I-Hsiang CHIU, Taipei (TW); Chun-Ting LEE, Taipei (TW)

(21) Appl. No.: 16/674,397

(22) Filed: Nov. 5, 2019

(30) Foreign Application Priority Data
Oct. 18, 2019 (CN) 201910994037.3

(51) Int. Cl. G06F 3/06

(52) U.S. Cl. CPC G06F 3/0653; G06F 3/0616; G06F 3/0688

(57) ABSTRACT

A server system includes at least one server. The server comprises a processing circuit and plural solid state drives. The plural solid state drives are connected with the processing circuit. A first solid state drive of the plural solid state drives includes a control circuit and a non-volatile memory. The control circuit is connected with the processing circuit. The non-volatile memory is connected with the control circuit. The control circuit includes a prediction model. The prediction model predicts a life time of the first solid state drive. If the prediction model predicts that the first solid state drive will be damaged in a specified time, the control circuit issues a critical warning signal to the processing circuit.

This application claims the benefit of People's Republic of China Patent Application No. 201910994037.3, filed Oct. 18, 2019, the subject matter of which is incorporated herein by reference.

### FIELD OF THE INVENTION

The present invention relates to a server system and an associated control method, and more particularly to a server system with solid state drives and an associated control method.

### BACKGROUND OF THE INVENTION

Generally, a data center is used for storing a large amount of data. In the data center, plural racks are combined as a network node. The network node can be connected to other network nodes through the internet in order to receive or transmit the data in the data center. For example, 1000 racks are combined as one network node in the data center.

In the data center, each rack contains plural blade servers, and a server system is defined by the plural blade servers collaboratively. For example, the server system in each rack is defined by 44 blade servers collaboratively. According to the blade functions of the blade server, the blade server is connected with plural solid state drives (SSD). For example, the blade server with a computing function is connected with 6 solid state drives, and the blade server with a data storing function is connected with 48 solid state drives.

FIG. 1 is a schematic functional block diagram illustrating the architecture of a conventional blade server. As shown in FIG. 1, the conventional blade server 100 comprises a processing circuit 110 and plural solid state drives 120, 130 and 140. The processing circuit 110 is connected with the plural solid state drives 120, 130 and 140. For example, the processing circuit 110 is connected with the plural solid state drives 120, 130 and 140 through peripheral component interconnect express buses (also referred as PCIe buses) 111, 112 and 113.

Since the structures of the solid state drives 120, 130 and 140 are identical, only the structure of the solid state drive 120 will be described as follows. The solid state drive 120 comprises a control circuit 122 and a non-volatile memory 124. The non-volatile memory 124 is a NAND flash memory. The non-volatile memory 124 comprises plural dies 126a-126n.

Each of the plural dies 126a-126n comprises plural memory cells. A memory cell array is defined by the plural memory cells collaboratively. In the non-volatile memory 124, the memory cell array is divided into plural blocks, and each block is divided into plural pages.

The processing circuit 110 can issue a write command or a read command to any solid state drive. For example, in the solid state drive 120, the control circuit 122 is connected with the non-volatile memory 124. According to the write command from the processing circuit 110, the write data from the processing circuit 110 is stored into the non-volatile memory 124 by the control circuit 122. According to the read command from the processing circuit 110, the read data is acquired from the non-volatile memory 124 by the control circuit 122 and transmitted to the processing circuit 110 through the control circuit 122.

When the data center is enabled, the blade servers of all racks are enabled. For example, all of the solid state drives 120, 130 and 140 in the blade server 100 are continuously enabled to store the write data from the processing circuit 110 or output the read data to the processing circuit 110.

While the processing circuit 110 stores the write data to the solid state drive 120, the control circuit 122 performs a program action on the memory cells of the dies 126a-126n. Consequently, the write data is stored into the non-volatile memory 124. Moreover, the control circuit 122 performs an erase action on the memory cells of the dies 126a-126n to erase the invalid data. After the solid state drive 120 has been operated for a long time, the program/erase (P/E) count is high. Meanwhile, some memory cells of the dies 126a-126n are damaged, and bad blocks are generated. Consequently, the read/write efficiency of the solid state drive 120 is impaired and the use life of the solid state drive 120 is shortened.

For maintaining the read/write efficiency and the use life of the solid state drive 120, the non-volatile memory 124 further comprises a spare die. If a specified die contains so many bad blocks, the specified die is replaced by the spare die by the control circuit 122. Consequently, the life time of the solid state drive 120 is prolonged.

Generally, the solid state drive 120 has a specified life time. After a long operating time period (e.g., 3 years), the non-volatile memory 124 may be damaged seriously and the solid state drive 120 cannot be operated normally. Under this circumstance, it is necessary to detach the solid state drive 120 from the blade server 100 and install a new solid state drive 120. Consequently, the blade server 100 can be operated continuously.

Since the old solid state drive 120 has been damaged, the data stored in the non-volatile memory 124 cannot be recovered completely. In other words, the data stored in the data center is lost.

For preventing from the damage of the solid state drive 120 and the data loss of the data center, the healthy information of the solid state drive 120 is outputted according to a command from the processing circuit 110. Moreover, according to the healthy information, the processing circuit 110 judges the status of the solid state drive 120 and determines whether the solid state drive 120 needs to be replaced.

For example, the existing solid state drive 120 has an S.M.A.R.T (Self-Monitoring Analysis and Reporting Technology) function. When the processing circuit 110 issues a detection command to the solid state drive 120, the control circuit 122 monitors the non-volatile memory 124 and generates a corresponding log data to the processing circuit 110. For example, the control circuit 122 issues the 512 byte log data to the processing circuit 110. The log data may be considered as the healthy information of the solid state drive 120. The contents of the healthy information contain the bad block count, the program time and the erase time of the non-volatile memory 124.

Moreover, the processing circuit 110 judges the status of the solid state drive 120 according to the healthy information. The healthy information of the solid state drive 120 may be transmitted from the processing circuit 110 to the manufacturer of the solid state drive 120. According to the healthy information, the manufacturer of the solid state drive 120 can judge the status of the solid state drive 120. If the status of the solid state drive 120 is not acceptable, the solid state drive 120 is can be replaced.

However, since the contents of the healthy information are limited, it is difficult for the processing circuit 110 to judge the status of the solid state drive 120 accurately. Similarly, it is difficult for the manufacturer of the solid state drive 120 to judge the status of the solid state drive 120 instantly and accurately.

### SUMMARY OF THE INVENTION

An embodiment of the present invention provides a server system. The server system includes at least one server. The server includes a processing circuit and plural solid state drives. The plural solid state drives are connected with the processing circuit. A first solid state drive of the plural solid state drives includes a control circuit and a non-volatile memory. The control circuit is connected with the processing circuit. The non-volatile memory is connected with the control circuit. The control circuit includes a prediction model. The prediction model predicts a life time of the first solid state drive. If the prediction model predicts that the first solid state drive will be damaged in a specified time, the control circuit issues a critical warning signal to the processing circuit.

Another embodiment of the present invention provides a control method for a server system. The server system includes at least one server. The server includes a processing circuit and plural solid state drives. A first solid state drive of the plural solid state drives includes a control circuit and a non-volatile memory. The control method includes the following steps. Firstly, a life time of the first solid state drive is predicted by a prediction model built in the control circuit of the first solid state drive. Then, plural parameters from the non-volatile memory are collected and inputted into the prediction model by the control circuit. If the prediction model predicts that the first solid state drive will be damaged in a specified time, the control circuit issues a critical warning signal to the processing circuit.

A further embodiment of the present invention provides a server system. The server system includes at least one server. The server includes a processing circuit and plural solid state drives. The plural solid state drives are connected with the processing circuit. Each of the plural solid state drives includes a control circuit and a non-volatile memory. The control circuit is connected with the processing circuit. The non-volatile memory is connected with the control circuit. The control circuit includes a prediction model. The prediction model predicts a life time of the corresponding solid state drive. If the prediction model predicts that the corresponding solid state drive will be damaged in a specified time, the control circuit of the corresponding solid state drive issues a critical warning signal to the processing circuit.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating the architecture of a conventional blade server;

FIG. 2 is a schematic functional block diagram illustrating the architecture of a blade server according to an embodiment of the present invention;

FIG. 3 is a flowchart illustrating a method of predicting the life time of the solid state drive of the blade server according to the embodiment of the present invention;

FIG. 4A is a plot illustrating the relationship between the probability density function of failure (PDF) f_{τ}(t) and the shape parameter m;

FIG. 4B is a plot illustrating the relationship between the hazard function h(t) and the shape parameter m;

FIG. 4C is a plot illustrating the relationship between the hazard function h(t) and the scale parameter η;

FIG. 5 is a plot illustrating the bathtub curve of the hazard function;

FIGS. 6A and 6B are plots illustrating the hazard function h(t) of the solid state drive after being subjected to an acceleration test at 45° C.; and

FIGS. 7A and 7B are plots illustrating the hazard function h(t) of the solid state drive after being subjected to an acceleration test at 70° C.

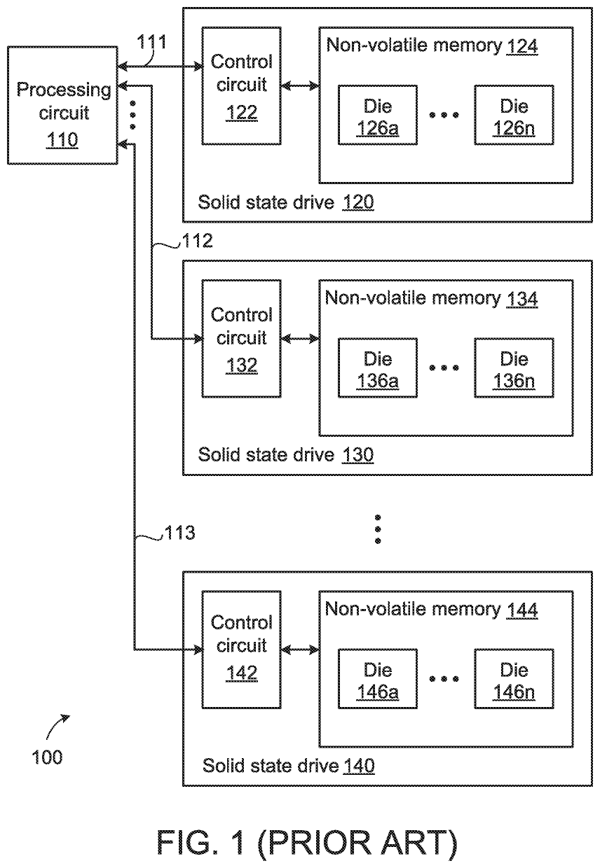

### DETAILED DESCRIPTION OF PREFERRED EMBODIMENTS

The present invention provides a server system and an associated control method. For preventing from data loss of the data center, the solid state drive of the blade server comprises a built-in prediction model for predicting the status of the solid state drive.

If the prediction model predicts that the solid state drive will be damaged in a specified time (e.g., in two months or in one month), the solid state drive issues a critical warning signal to the processing circuit. Consequently, before the solid state drive is damaged completely, the user can detach the solid state drive from the blade server and install a new solid state drive. Since the old solid state drive is not damaged completely, the entire of the stored data can copied to the new solid state drive. Consequently, the stored data in the data center is not lost.

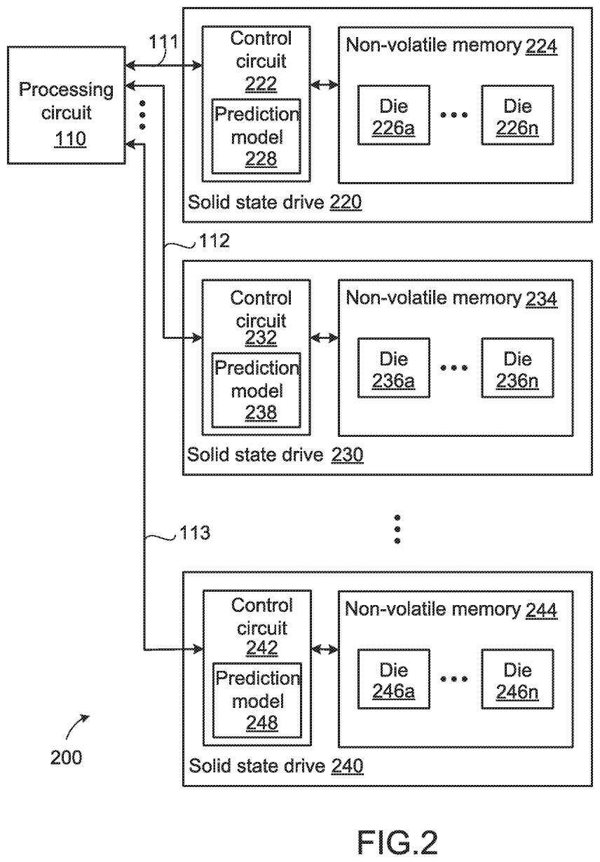

FIG. 2 is a schematic functional block diagram illustrating the architecture of a blade server according to an embodiment of the present invention. As shown in FIG. 2, the blade server 200 comprises a processing circuit 110 and plural solid state drives 220, 230 and 240. The processing circuit 110 is connected with the plural solid state drives 220, 230 and 240. For example, the processing circuit 110 is connected with the plural solid state drives 220, 230 and 240 through peripheral component interconnect express buses (also referred as PCIe buses) 111, 112 and 113.

In the data center, each rack contains plural blade servers, and a server system is defined by the plural blade servers collaboratively. For example, the server system in each rack is defined by 44 blade servers collaboratively.

Since the structures of the solid state drives 220, 230 and 240 are identical, only the structure of the solid state drive 220 will be described as follows. The solid state drive 220 comprises a control circuit 222 and a non-volatile memory 224. The non-volatile memory 224 is a NAND flash memory. The non-volatile memory 224 comprises plural dies 226a-226n. Each of the plural dies 226a-226n comprises plural memory cells. A memory cell array is defined by the plural memory cells collaboratively. In the non-volatile memory 124, the memory cell array is divided into plural blocks, and each block is divided into plural pages.

In the blade server 200, the processing circuit 110 can issue a write command or a read command to any solid state drive. For example, in the solid state drive 220, the control circuit 222 is connected with the non-volatile memory 224. According to the write command from the processing circuit 110, the write data from the processing circuit 110 is stored into the non-volatile memory 224 by the control circuit 222. According to the read command from the processing circuit 110, the read data is acquired from the non-volatile memory 224 by the control circuit 222 and transmitted to the processing circuit 110 through the control circuit 222.

Each solid state drive comprises a prediction model for predicting the status of the solid state drive. As shown in the drawing, the solid state drive 220 comprises a prediction model 228, the solid state drive 230 comprises a prediction model 238, and the solid state drive 240 comprises a prediction model 248. For example, the prediction model 228 is built in the control circuit 222 of the solid state drive 220. According to plural parameters of the non-volatile memory 224, the prediction model 228 performs the life time prediction. The parameters of the non-volatile memory 224 contains the operating temperature, the operating voltage, the program/erase count, the bad block count, the program time, the erase time, the data error rate, and so on.

During the operations of the blade server 200, the prediction model 228 of the control circuit 222 predicts the status of the solid state drive 200. If the prediction model 228 of the control circuit 222 predicts that the solid state drive 220 will be damaged in a specified time, the solid state drive 200 issues a critical warning signal to the processing circuit 110. Consequently, before the solid state drive 200 is damaged completely, the user can detach the solid state drive 220 from the blade server 200 and install a new solid state drive 220. Since the old solid state drive 220 is not damaged completely, the entire of the stored data can copied to the new solid state drive. Consequently, the stored data in the data center is not lost.

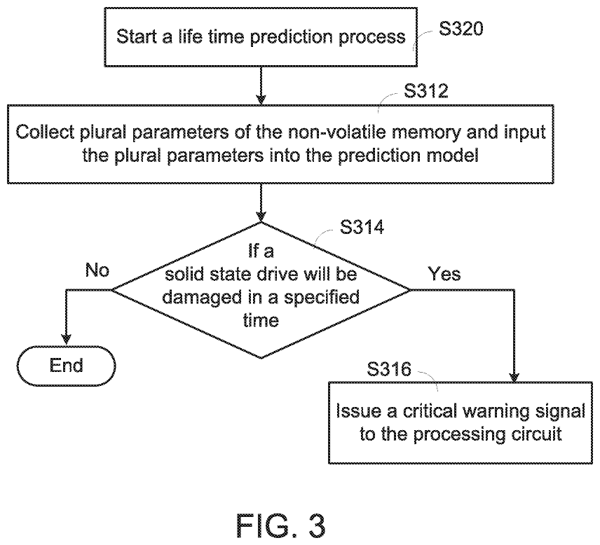

FIG. 3 is a flowchart illustrating a method of predicting the life time of the solid state drive of the blade server according to the embodiment of the present invention. After the solid state drive 220 has been operated for a specified period (e.g., 12 hours or 24 hours), the control circuit 222 starts a life time prediction process (Step S320). Then, the control circuit 222 collects plural parameters of the non-volatile memory 224 and inputs the plural parameters into the prediction model 228 (Step S312). Then, the prediction model 228 predicts whether the solid state drive 220 will be damaged in a specified time (Step S314). If the prediction model 228 predicts that the solid state drive 220 will be damaged in the specified time, the control circuit 222 issues a critical warning signal to the processing circuit 110 (Step S316). Whereas, if the prediction model 228 predicts that the solid state drive 220 will not be damaged in the specified time, the control circuit 222 stops the life time prediction process. After the solid state drive 220 has been operated for another specified period, the control circuit 222 starts another life time prediction process (Step S320).

According to the physical characteristics of the flash memory, the block of the flash memory has the limited life time. For example, if the solid state drive is operated in a high-temperature environment, the life time of the block is shortened.

The failure rate of the life time of the flash memory may be expressed by Weibull distribution, which contains an exponential distribution function. Since the failure rate changes with time, Weibull distribution is suitable for predicting the life time of the flash memory.

In an embodiment, the prediction model 228 of the control circuit 222, the prediction model 238 of the control circuit 232 and the prediction model 248 of the control circuit 242 are Weibull distribution prediction models. That is, the Weibull distribution prediction models are used to predict the non-volatile memories (i.e., flash memories) 224, 234 and 244, and the failure function is used to predict the life time of the blocks of the flash memories.

According to the Weibull distribution, the cumulative distribution function of failure (CDF) F_{T}(t) may be expressed as the following mathematic formula:

$${F}_{T} ( t ) = 1 - {e}^{[ - {( \frac{t}{η} )}^{m} ]}$$

The differential of the cumulative distribution function of failure (CDF) F_{T}(t) may be expressed by a probability density function of failure (PDF) f_{τ}(t):

$${f}_{T} ( t ) = \frac{m}{η} {( \frac{t}{η} )}^{m - 1} \cdot {e}^{[ - {( \frac{t}{η} )}^{m} ]}$$

Moreover, a hazard function h(t) is also referred as a failure function and expressed as the following mathematic formula:

$$h ( t ) = \frac{{f}_{T} ( t )}{1 - {F}_{T} ( t )} = \frac{m}{η} {( \frac{t}{η} )}^{m - 1}$$

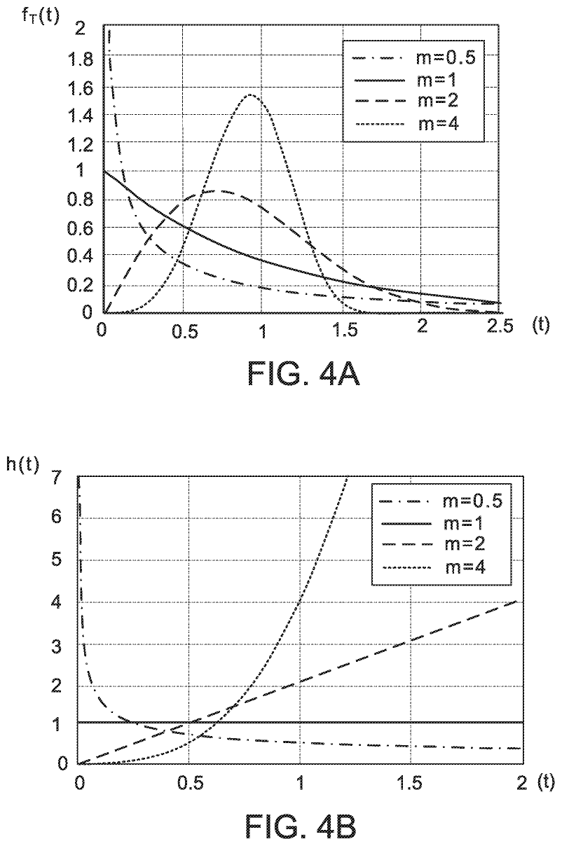

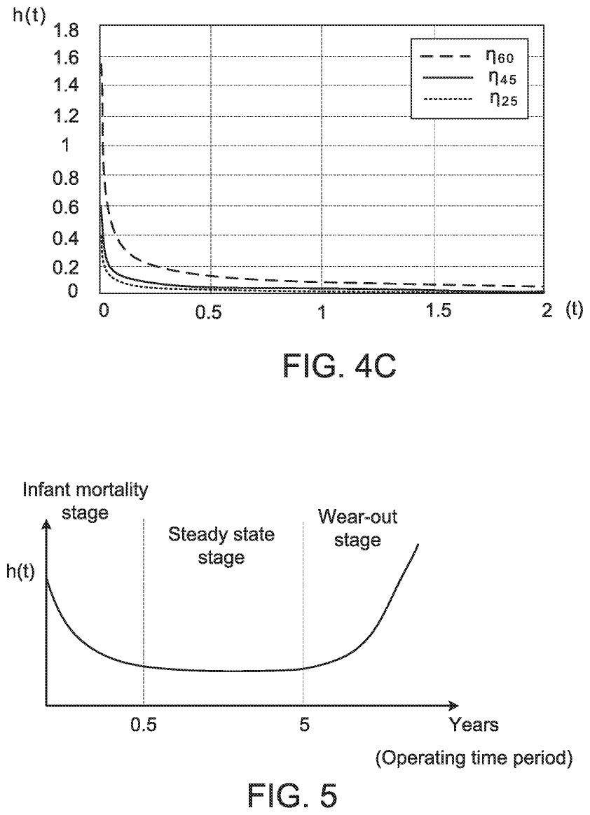

In the above mathematic formula, m is a shape parameter. The shape of the distribution of the mathematic formula may be determined according to the shape parameter m. FIG. 4A is a plot illustrating the relationship between the probability density function of failure (PDF) f_{τ}(t) and the shape parameter m. FIG. 4B is a plot illustrating the relationship between the hazard function h(t) and the shape parameter m. As the value of the shape parameter m is changed, the distribution shape of the probability density function of failure (PDF) f_{τ}(t) and the distribution shape of the hazard function h(t) are changed.

Moreover, η is a scale parameter. The scale parameter η is related to the average life time. Generally, the scale parameter η is changed with the change of the environment (e.g., the operating temperature). For example, if the shape parameter m is 0.5, the scale parameter at 25° C. is η₂₅ and the scale parameter at 60° C. is η₁₆₀. The prediction result indicates that the scale parameter at 45° C. is η₁₄₅, wherein η₆₀<η₄₅<η₂₅. FIG. 4C is a plot illustrating the relationship between the hazard function h(t) and the scale parameter η.

Generally, the hazard function of the solid state drive has the shape similar to a bathtub. That is, the hazard function has a bathtub curve. FIG. 5 is a plot illustrating the bathtub curve of the hazard function. According to the operating time period of the solid state drive, the bathtub curve includes an infant mortality stage, a steady state stage and a wear-out stage. For example, the infant mortality stage of the bathtub curve is a half year after the solid state drive is used, the steady state stage of the bathtub curve is in the range of a half year and the 5 years after the solid state drive is used, and the wear-out stage of the bathtub curve is 5 years after the solid state drive is used.

The infant mortality stage of the bathtub curve is the early stage of using the solid state drive. The initial value of the failure rate is high. The value of the failure rate decreases with time. The failure rate in the infant mortality stage of the bathtub curve is resulted from the congenital defects of the non-volatile memory or the control circuit. In the steady state stage of the bathtub curve, the value of the failure rate is stable and nearly maintained at a constant. The failure rate in the steady state stage of the bathtub curve is generated randomly or unexpectedly. The wear-out stage of the bathtub curve is the final stage of the life time. As the performance of the solid state drive is gradually degraded because of the long-term reading/writing operation, the failure rate is quickly increased with time. Finally, the solid state drive is damaged.

The Weibull distribution can be used to simulate the three stages of the bathtub curve of the solid state drive. Please refer to FIG. 4B. When the shape parameter m of the hazard function is lower than 1 (i.e., m<1), the curve of the hazard function is similar to the infant mortality stage of the bathtub curve. When the shape parameter m of the hazard function is equal 1 (i.e., m=1), the curve of the hazard function is similar to the steady state stage of the bathtub curve. When the shape parameter m of the hazard function is higher than 1 (i.e., m>1), the curve of the hazard function is similar to the wear-out stage of the bathtub curve. In other words, the life time of the solid state drive can be predicted according to the shape parameter m of the hazard function higher than 1 (i.e., m>1).

For providing the prediction model of the solid state drive with the proper hazard function h(t), the scale parameter η of the hazard function h(t) can be simulated by an acceleration test according to an acceleration factor. For example, the acceleration factor includes a temperature acceleration factor A_{F}^{T}, a voltage acceleration factor A_{F}^{V}, a stress acceleration factor A_{F}^{f} or an atmospheric pressure acceleration factor A_{F}^{P}. In an embodiment, the use of an Arrhenius model can be used to obtain the acceleration factor.

The temperature acceleration factor may be expressed as the following mathematic formula:

$${A}_{F}^{T} = \frac{{L}_{normal}}{{L}_{s t r e s s}} = {e}^{[ \frac{{E}_{a}}{k} ( \frac{1}{{T}_{u}} - \frac{1}{{T}_{A}} ) ]}$$

In the above mathematic formula, A_{F}^{T} is the temperature acceleration factor, Lₙₒᵣₘₐₗ is the life time of the solid state drive in the normal condition, Lₛₜᵣₑₛₛ is the life time of the solid state drive in the acceleration condition, Eₐ is the activation energy, k is the Boltzmann constant, Tᵤ is the absolute temperature in the normal condition, and T_{A} is the absolute temperature in the acceleration condition.

The voltage acceleration factor may be expressed as the following mathematic formula:

A_{F}^{V}=e^{[α(V}^{ₐ}^{-V}^{ᵤ}^{)]}

In the above mathematic formula, A_{F}^{V} is the voltage acceleration factor, α is the voltage acceleration rate coefficient, Vᵤ is the voltage in the normal condition, and V_{A} is the voltage in the acceleration condition.

The stress acceleration factor may be expressed as the following mathematic formula:

A_{F}^{f}=e^{[β(f}^{ₐ}^{-f}^{ᵤ}^{)]}

In the above mathematic formula, A_{F}^{f} is the stress acceleration factor, β is the stress acceleration rate coefficient, fᵤ is the stress in the normal condition, and f_{A} is the stress in the acceleration condition.

The pressure acceleration factor may be expressed as the following mathematic formula:

A_{F}^{P}=e^{[γ(P}^{ₐ}^{-P}ᵤ^{)]}

In the above mathematic formula, A_{F}^{P} is the pressure acceleration factor, γ is the atmospheric pressure acceleration rate coefficient, Pᵤ is the atmospheric pressure in the normal condition, and P_{A} is the atmospheric pressure in the acceleration condition.

Consequently, the accumulated acceleration factor may be expressed as the following mathematic formula:

AFₐₗₗ=A_{F}^{T}×A_{F}^{V}×A_{F}^{f}×A_{F}^{P}

Moreover, the mean time between failure (MTBF) may be expressed as the following mathematic formula:

$$M T B F = \frac{Total time \times {AF}_{all}}{Total ratio}$$

According to the above parameters, the scale parameter η and the corresponding hazard function h(t) can be simulated. Consequently, the life time of the solid state drive can be predicted.

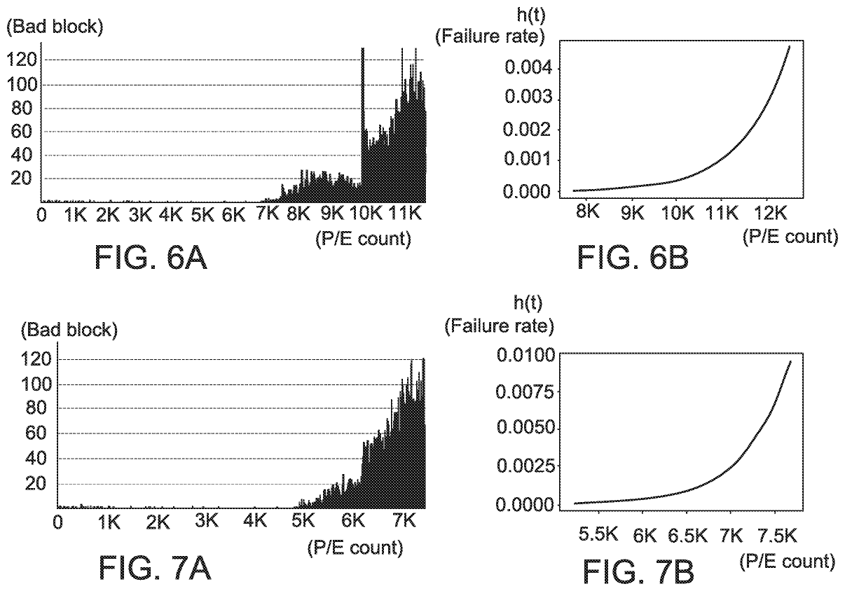

FIGS. 6A and 6B are plots illustrating the hazard function h(t) of the solid state drive after being subjected to an acceleration test at 45° C. FIGS. 7A and 7B are plots illustrating the hazard function h(t) of the solid state drive after being subjected to an acceleration test at 70° C.

Generally, if the number of the bad blocks in the non-volatile memory exceeds a specified count, the non-volatile memory is damaged. In the acceleration tests of FIGS. 6A and 7A, the temperature is used as the acceleration factor and the number of the bad blocks is used as the failure factor for judging the non-volatile memory. As shown in FIGS. 6A and 7A, the number of the bad blocks increases with the increasing P/E count. If the P/E count of the block at the 70° C. test condition exceeds 5000, the number of the bad blocks has the tendency of starting to increase. If the P/E count of the block at the 45° C. test condition exceeds 7000, the number of the bad blocks has the tendency of starting to increase. That is, the tendency to increase at 70° C. is earlier than the tendency to increase at 45° C.

According to the test results as shown in FIGS. 6A and 7A, the Weibull-based hazard functions as shown in FIGS. 6B and 7B are obtained. FIGS. 6B and 7B illustrate the hazard function h(t) of the solid state drive at 45° C. and 70° C. According to the hazard functions as shown in FIGS. 6B and 7B, the hazard functions corresponding to other temperatures can be deduced and established in the prediction model of the control circuit. As mentioned above, the hazard function h(t) corresponding to other temperature is the hazard function h(t) corresponding to the different scale parameter η. In addition, the hazard function h(t) corresponding to other temperature may be deduced according to the hazard function h(t) of the solid state drive at 45° C. and 70° C.

In addition to the temperature, the acceleration test may be performed according to the other parameters or plural parameters can be used as the acceleration factors (e.g., the operating temperature, the operating voltage, the read/write frequency, the atmospheric pressure, the data error rate and the P/E count). Consequently, the corresponding hazard function h(t) is obtained and used as the prediction model. During the life time prediction of the solid state drive, the control circuit collects the plural parameters of the non-volatile memory (e.g., the operating temperature, the operating voltage, the read/write frequency, the atmospheric pressure, the data error rate and the P/E count) and inputs these parameters into the prediction model. The prediction model calculates the life time of the solid state drive according to the corresponding hazard function. If the prediction model predicts that the solid state drive will be damaged in a specified time, the solid state drive issues a critical warning signal to the processing circuit.

From the above descriptions, the present invention provides a server system with solid state drives and an associated control method. The server system comprises at least one blade server. The server system is applied to the data center. The blade server comprises plural solid state drives. The control circuit of the solid state drive comprises a built-in prediction model for predicting the life time of the solid state drive. If the prediction model predicts that the solid state drive will be damaged in a specified time (e.g., in two months or in one month), the solid state drive issues a critical warning signal to the processing circuit. Consequently, before the solid state drive is damaged completely, the user can detach the solid state drive from the blade server and install a new solid state drive. Since the old solid state drive is not damaged completely, the entire of the stored data can copied to the new solid state drive. Consequently, the stored data in the data center is not lost

Moreover, the solid state drive of the blade server in the server system comprises the built-in prediction model for predicting the life time of the solid state drive. In comparison with the conventional server system of using the processing circuit to predict the life time of each solid state drive, the technology of the present invention is beneficial. Since the status parameters of the solid state drives acquired by the built-in prediction models of the solid state drives are closer to the practical condition, the prediction results according to the status parameters of the solid state drives are more accurate.

In the above embodiment, the server system is defined by the plural blade servers collaboratively. Alternatively, in another embodiment, plural servers with the similar functions (e.g., rack mount servers) are collaboratively formed as a server system. The built-in prediction models in the solid state drives of these servers are used to predict the life times of the corresponding solid state drives.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A server system comprising at least one server, the server comprising:
a processing circuit; and
plural solid state drives connected with the processing circuit,
wherein a first solid state drive of the plural solid state drives comprises a control circuit and a non-volatile memory, the control circuit is connected with the processing circuit, the non-volatile memory is connected with the control circuit, the control circuit comprises a prediction model, and the prediction model predicts a life time of the first solid state drive,
wherein if the prediction model predicts that the first solid state drive will be damaged in a specified time, the control circuit issues a critical warning signal to the processing circuit,
wherein the prediction model is a Weibull distribution prediction model and has a hazard function for predicting the life time of the first solid state drive, the hazard function is expressed as the following mathematic formula:
$$h ( t ) = \frac{m}{η} {( \frac{t}{η} )}^{m - 1}$$
wherein, m is a shape parameter, η is a scale parameter, and the shape parameter m of the hazard function larger than 1.

2. The server system as claimed in claim 1, wherein after the critical warning signal is received by the processing circuit, the first solid state drive is detached from the server system, and an additional solid state drive is connected with the processing circuit to replace the first solid state drive.

3. The server system as claimed in claim 1, wherein the scale parameter η of the hazard function h(t) is simulated by an acceleration test according to at least an acceleration factor to obtain the hazard function h(t) corresponding to the scale parameter η, the acceleration factor includes a temperature acceleration factor, a voltage acceleration factor, a stress acceleration factor and an atmospheric pressure acceleration factor.

4. The server system as claimed in claim 1, wherein the control circuit collects plural parameters from the non-volatile memory and inputs the plural parameters into the Weibull distribution prediction model, and the life time of the first solid state drive is predicted by the Weibull distribution prediction model according to the plural parameters.

5. The server system as claimed in claim 4, wherein the plural parameters contain at least two of an operating temperature, an operating voltage, a program/erase count, a bad block count, a program time, an erase time and a data error rate.

6. A control method for a server system comprising at least one server, the server comprising a processing circuit and plural solid state drives, a first solid state drive of the plural solid state drives comprising a control circuit and a non-volatile memory, the control method comprising steps of:
predicting a life time of the first solid state drive by a prediction model built in the control circuit of the first solid state drive;
collecting plural parameters from the non-volatile memory and inputting the plural parameters into the prediction model by the control circuit; and
if the prediction model predicts that the first solid state drive will be damaged in a specified time, the control circuit issues a critical warning signal to the processing circuit,
wherein the prediction model is a Weibull distribution prediction model and has a hazard function for predicting the life time of the first solid state drive, the hazard function is expressed as the following mathematic formula:
$$h ( t ) = \frac{m}{η} {( \frac{t}{η} )}^{m - 1}$$
wherein, m is a shape parameter, η is a scale parameter, and the shape parameter m of the hazard function larger than 1.

7. The control method as claimed in claim 6, wherein after the critical warning signal is received by the processing circuit, the first solid state drive is detached from the server system, and an additional solid state drive is connected with the processing circuit to replace the first solid state drive.

8. The control method as claimed in claim 6, wherein the scale parameter η of the hazard function h(t) is simulated by an acceleration test according to at least an acceleration factor to obtain the hazard function h(t) corresponding to the scale parameter η, the acceleration factor includes a temperature acceleration factor, a voltage acceleration factor, a stress acceleration factor and an atmospheric pressure acceleration factor.

9. The control method as claimed in claim 6, wherein the plural parameters contain at least two of an operating temperature, an operating voltage, a program/erase count, a bad block count, a program time, an erase time and a data error rate.

10. A server system comprising at least one server, the server comprising:
a processing circuit; and
plural solid state drives connected with the processing circuit,
wherein each of the plural solid state drives comprises a control circuit and a non-volatile memory, wherein, in each of the plural solid state drives, the control circuit is connected with the processing circuit, the non-volatile memory is connected with the control circuit, the control circuit comprises a prediction model, and the prediction model predicts a life time of the corresponding solid state drive,
wherein if the prediction model predicts that the corresponding solid state drive will be damaged in a specified time, the control circuit of the corresponding solid state drive issues a critical warning signal to the processing circuit,
wherein the prediction model is a Weibull distribution prediction model and has a hazard function for predicting the life time of the first solid state drive, the hazard function is expressed as the following mathematic formula:
$$h ( t ) = \frac{m}{η} {( \frac{t}{η} )}^{m - 1}$$
wherein, m is a shape parameter, η is a scale parameter, and the shape parameter m of the hazard function larger than 1,
wherein the scale parameter η of the hazard function h(t) is simulated by an acceleration test according to at least an acceleration factor to obtain the hazard function h(t) corresponding to the scale parameter η.
